(19) United States
(12) Patent Application Publication
(10) Pub. No.: US 2011/0019436 A1
(43) Pub. Date: Jan. 27, 2011

(54) LIGHTING SYSTEM WITH REMOVABLE LIGHT EXTRACTING MEMBER

(75) Inventor: Johannes Lambrecht Marinus Van Den Berge, Mijdrecht (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/919,228

(22) PCT Filed: Mar. 2, 2009
(86) PCT No.: PCT/IB09/50827

§ 371 Date: Aug. 25, 2010

(30) Foreign Application Priority Data
Mar. 7, 2008 (EP) 08152446.4

(51) Int. Cl. F21V 7/22

(52) U.S. Cl. 362/608; 362/613

(57) ABSTRACT

The present invention relates to a lighting system (100) comprising at least one light source (101), a light guide (102) which is arranged to receive light emitted by the light source(s) (101) and at least one light extracting member (103). The light extracting member(s) (103) is adapted to extract light from the light guide, and is removably arranged on a surface of the light guide (102). The light extracting member is removably arranged on the light guide meaning that it may be detached from and moved to a different position on the light guide. Light may thus be extracted at any desired position, and this allows for a controlled and variable extraction of light.

### TECHNICAL FIELD

The present invention relates to a lighting system comprising at least one light source, a light guide arranged to receive light emitted by said at least one light source and at least one light extracting member adapted to extract light from said light guide.

### BACKGROUND OF THE INVENTION

Semiconductor light-emitting devices comprising light emitting diodes (LEDs) are among the most efficient and robust light sources currently available. Due to their small size, potential energy savings and long life, LEDs are rapidly evolving to become a viable light source for general lighting applications.

For several new LED based lighting systems, additional optics, such as light guides are used in order to produce general ambient lighting. A light guide, typically a flat or curved piece of transparent plastic or glass, usually serves two purposes. Its primary intention is to guide light without losses from one position to another. That is, as long as light is reflected off the sides with an angle sufficiently large with respect to the normal, no light is lost at all. Hence, one of the purposes of a light guide is to guide light from a light source to a desired spot. As another purpose, a light guide is also used to mix the colors from individually colored light emitting elements. Hence, by guiding light of different colors through a light guide of a sufficient length, a mixed output of the colors can be obtained.

In general, light guides operate on the principle of total internal reflection (TIR), whereby light travelling through the light guide is reflected at the surfaces of the light guide based on differences in the indices of refraction of the material of the light guide and the material immediately surrounding the light guide, e.g. air, cladding, etc. Only when light encounters a surface with an angle sufficiently close to the normal, light may exit the light guide

In some applications, it might be desirable to steer the light which is extracted from the light guide in a more controlled way and to vary the position where light is extracted for different applications.

Accordingly, there is a need in the art to provide a lighting system in which light extraction may be controlled and varied depending on the application.

### SUMMARY OF THE INVENTION

One object of the present invention is to fulfill the above mentioned need and to provide a light emitting system in which light extraction may be more exactly controlled and varied for different applications.

This and other objects of the present invention are achieved by a lighting system according to the appended claims.

Thus, in a first aspect the present invention relates to a lighting system comprising at least one light source and a light guide. The light guide is arranged to receive light emitted by the at least one light source. The lighting system further comprises at least one light extracting member which is adapted to extract light from the light guide. The light extracting member(s) is(are) removably arranged on a surface of the light guide.

In a device of the present invention, at least part of the light that is emitted by the light source is received by the light guide. Light entering the light guide within an acceptable angular range is contained by total internal reflection within the light guide. Due to the difference in refractive indices between the light extracting member(s) and the surrounding, light is extracted from the light guide.

The light extracting member is removably arranged on the light guide meaning that it may be detached from and moved to a different position on the light guide. Light may thus be extracted at any desired position, and this allows for a controlled and variable extraction of light.

In embodiments of the invention, the at least one light extracting member comprises at least one scattering material which serves to disturb the beam path, and thus the phenomenon of total internal reflection such that light is efficiently extracted from the light guide through the light extracting member(s).

Preferably, the scattering material comprises a wavelength converting material. Thus, light entering the light extracting member will, upon contact with the wavelength converting material dispersed therein, be converted into light of a different wavelength. Accordingly, light might enter the light guide at a certain wavelength and color and may then exit the light guide with a different wavelength and color.

The fact that the light extracting member comprising wavelength converting material(s) is not directly attached to the light source, but is instead arranged remote from the light source is advantageous for several reasons. This so called “remote phosphor” application alleviates the requirements with respect to temperature and light flux that the phosphor; i.e. wavelength converting material can withstand. Therefore, a low color temperature and a good color rendering index can be obtained. Furthermore, the light quality (unpleasant peak brightness, color control) may be improved and the color may be controlled by varying the properties of the wavelength converting material.

In a preferred embodiment of the present invention, the light extracting member is deformable. In this embodiment, the thickness of the deformable light extracting member can be varied.

When the deformable member comprises wavelength converting material(s), this wavelength converting material(s), and hence also the color of the output light may be “tuned” by varying the thickness of the member. Accordingly, a large degree of design and aesthetic freedom is obtained and the color of the output light may be easily shifted.

In embodiments of the invention, the at least one light extracting member comprises a gel. The gel increases the deformability of the element, which in turn results in that the thickness of the light extracting member, and thereby the color output can be varied.

According to a preferred embodiment, the light extracting member has an adhesive surface which allows for the adherence onto a surface of the light guide. Hence, the light extracting member(s) can be removed from the light guide and arranged at a different position, thereby providing a controlled light extraction which may be varied from application to application.

These and other aspects of the invention will be apparent from and elucidated with reference to the embodiment(s) described hereinafter.

### BRIEF DESCRIPTION OF THE DRAWINGS

FIG. 1 illustrates a lighting system according to the present invention.

### DETAILED DESCRIPTION OF THE EMBODIMENTS

The present invention relates to a lighting system comprising at least one light source, a light guide arranged to receive light emitted by said at least one light source and at least one light extracting member adapted to extract light from said light guide, wherein said light extracting member is removably arranged on a surface of said light guide.

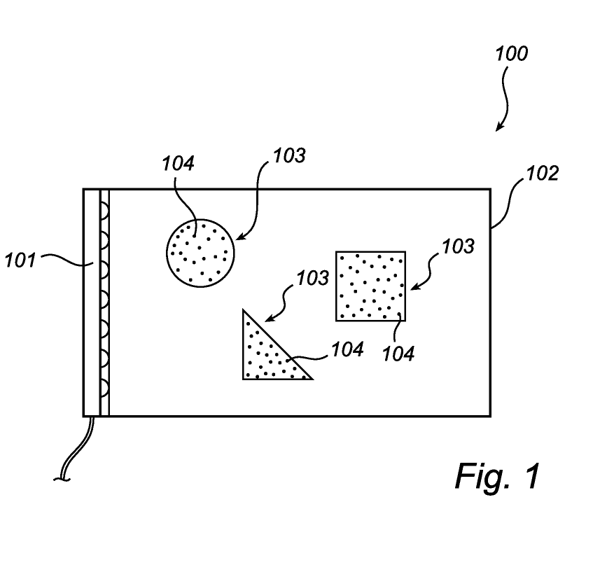

One embodiment of a lighting system 100 according to the present invention is illustrated in FIG. 1. The lighting system 100 comprises at least one light source 101 and a light guide 102 which is arranged to receive light emitted by the light source(s) 101. The lighting system 100 further comprises at least one light extracting member 103 adapted to extract light from the light guide 102. The light extracting member(s) 103 is(are) removably arranged on a surface of the light guide 102.

As used herein, the term “light source” may be any source of light, but in this context it typically refers to one or more light emitting diode(s) (LEDs). LEDs are advantageously used due to their small size, potential energy savings and long life

At least part of the light emitted by the light source 101 is received by the light guide 102. Upon entrance into the light guide 102, light is contained by total internal reflection as it travels along the length of the light guide 102.

Light is then extracted from the light extracting member(s) 103 due to the difference in refractive index between the light extracting member(s) 103 and the surroundings.

As used herein, the term “light guide” refers to an article that receives light at an input end and propagates the light to an output end or an extraction mechanism without significant losses. In general, light guides operate on the principle of total internal reflection, which is a phenomenon where a light beam is totally reflected in the interface between two medias, i.e. no light passes the interface. The passage of a light beam through a surface is bound to Snell's law:

n₁sin(θ₁)=n₂sin(θ₂).

In this formula n₁ is the refractive index in the first media and θ₁ is the angle of incidence on the interface in the first media, and n₂ is the refractive index in the second media and θ₂ is the angle of incidence on the interface in the second media. If n₁>n₂, there does not exist any solution to Snell's law in case θ₁ is large. Above a critical angle θ_{C} (where θ_{C}=arcsin(n₂/n₁)), this means that a light beam encountering the interface from the first medium, is fully reflected, without any light passing the surface. This yields a critical angle for TIR at the interfacing surface, i.e. light incident at the interface at angles larger than the critical angle are totally internally reflected.

The light extracting member 103 is adapted to “disturb” the beam bath, and thereby the phenomenon of total internal reflection such that light is extracted from the light extracting member(s) 103. In order to disturb the beam bath and for light extraction to occur, the surface of the light extracting member 103 facing the surrounding may e.g. be curved, grooved or structured.

Typically the light guide 102 comprises an optically clear material, such as glass or polymers.

The term “optically clear” means that the light guide absorbs none or only minor amounts of light of the desired wavelengths passing through the light guide. Such optically clear materials can be seen through, i.e. they allow clear images to pass.

The at least one light extracting member 103 is removably arranged on the light guide 102. Hence, it may be detached from the light guide 102 and moved to a different position on the light guide 102. Light could thus be extracted at any desired position. This allows for a controlled and variable extraction of light which could be varied for different applications.

In embodiments of the invention, the at least one light extracting member 103 comprises at least one scattering material. Such scattering material serves to disturb the beam path, and thereby total internal reflection, allowing light to be extracted from the light extracting member(s) 103.

Such scattering material may be any type of material which serves to disturb the beam path contained in the light guide due to total internal reflection. For example, TiO₂ particles could be used.

In embodiments of the invention, the at least one scattering material comprises at least one wavelength converting material 104. Hence, in a preferred aspect, particles of wavelength converting material 104 are dispersed within the light extracting member(s) 103. Accordingly, light from the light guide 102 which enters the light extracting member 103 will, upon contact with the wavelength converting material(s) 104, be converted into light of a different wavelength. Accordingly, light which enters the light guide 102 at a certain wavelength and color may then be extracted from the light extracting member(s) 103 having a different wavelength and color.

Several light extracting members 103 may be arranged on the light guide 102 and these may comprise different types of wavelength converting materials 104 such that the color of the output light may be varied between each of the light extracting members 103. Furthermore, more than one wavelength converting materials 104 may be comprised in the extracting member 103 giving a mixed color impression.

As used herein, the term “wavelength converting material” refers to a material that absorbs light of a first wavelength resulting in the emission of light of a second, longer wavelength. Upon absorption of light, electrons in the material become excited to a higher energy level. Upon relaxation back from the higher energy levels, the excess energy is released from the material in form of light having a longer wavelength than of that absorbed. Hence, the term relates to both fluorescent and phosphorescent wavelength conversion

When the light extracting members 103 comprise wavelength converting material 104, such members 103 are typically arranged remote from the light source 101 and not directly attached thereto. This so called “remote phosphor” application alleviates the requirements with respect to temperature and light flux that the phosphor; i.e. wavelength converting material can withstand. In traditional LEDs the wavelength converting material is embedded in glue that is directly attached to the chip. In this construction the wavelength converting material has to withstand the temperature of the LED and the light flux at the same time. Therefore, this arrangement allows for a low color temperature and a good color rendering index. Also, the light quality (unpleasant peak brightness, color control) may be improved and the color of the extracted light may be easily controlled by varying the properties of the wavelength converting material 104.

In a preferred embodiment of the present invention, the light extracting member 103 is deformable. This is advantageous since the thickness of the deformable element, and hence also the color of the output light can be varied.

As used herein, the term “deformable element” refers to an element formed from a highly flexible material, the element being bendable and plastic such that the thickness of the element may be varied, either locally or in general.

In embodiments, where the deformable member 103 comprises wavelength converting material(s) 104, this wavelength converting material 104 may be “tuned”, and accordingly the color of the output light can be shifted. This allows for color variation with the same power output all the time and a large degree of design and aesthetic freedom.

In embodiments of the invention, the at least one light extracting member 103 comprises a gel, which further increases its deformability and flexibility. This in turn results in that the thickness of the member, and thereby the color output may be more easily varied. Typically, the gel comprises silicone, which is a flexible, inert and thermally stable material.

However, the present invention is not limited to the use of silicone, but several other deformable materials, e.g. highly viscose organic material may also be used and these are known to a person skilled in the art.

Preferably the gel, and thus also the deformable light extracting member is optically clear.

According to a preferred embodiment, the light extracting member 103 has an adhesive surface which allows for the adherence onto a surface of the light guide 102. Hence, the light extracting member(s) 103 can be easily removed from the light guide 102 and arranged at a different position. This allows for a controlled light extraction which also may be varied from application to application.

In embodiments of the invention, additional optics, such as for example a heat sink may be arranged to transport heat away from the light emitting device. Furthermore, a diffusor could optionally be used to receive light emitted by the light source(s) in order to generate a homogenous and diffuse light output.

The lighting system according to the present invention may be used in several applications, e.g. as a memoboard or as a down lighter with local light source. The lightguide may for instance be mounted above a table and the light extracting member(s) may be placed where light extraction is desired. Furthermore the lighting system could be utilized in a chess game, where the chessboard could serve as the light guide and the chessmen as the light extracting members. The light extracting members could also be used as window/bus stop stickers and placed on a window serving as the light guide.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. For example, the present invention is not limited to the use of a specific light source, but any source of light may be used. Typically light emitting diodes (LEDs) are used, but the invention is not limited to a specific type of LED. Neither is it limited to a specific wavelength converting material, but any such material or combination of materials may be used.

1. A lighting system comprising at least one light source, a light guide arranged to receive light emitted by said at least one light source and at least one light extracting member adapted to extract light from said light guide, wherein said at least one light extracting member is removably arranged on a surface of said light guide.

2. A lighting system according to claim 1, wherein said light extracting member comprises at least one scattering material.

3. A lighting system according to claim 2, wherein said at least one scattering material is a wavelength converting material.

4. A lighting system according to claim 1, wherein said light extracting member is deformable.

5. A lighting system according to claim 4, wherein said light extracting member comprises a gel.

6. A lighting system according to claim 1, wherein said light extracting member has an adhesive surface for facilitating adherence onto a surface of said light guide.
